(19) United States
(12) Patent Application Publication
(10) Pub. No.: US 2023/0177309 A1
(43) Pub. Date: Jun. 8, 2023

(54) TRAINING CONDITIONAL COMPUTATION NEURAL NETWORKS USING REINFORCEMENT LEARNING

(71) Applicant: DeepMind Technologies Limited, London (GB)

(72) Inventors: Aidan Clark, London (GB); Arthur Mensch, Paris (FR)

(21) Appl. No.: 18/076,978

(22) Filed: Dec. 7, 2022

Related U.S. Application Data
(60) Provisional application No. 63/286,923, filed on Dec. 7, 2021.

(51) Int. Cl. G06N 3/04

(52) U.S. Cl. CPC G06N 3/0427

(57) ABSTRACT

Methods, systems, and apparatus, including computer programs encoded on a computer storage medium, for training a neural network having one or more conditional computation layers, where each conditional computation layer includes a gating sub-layer having multiple gating parameters and an expert sub-layer having multiple expert neural networks. In one aspect, a method comprises: sampling a batch of target output sequences that comprises a respective ground truth output token at each of multiple output positions; for each target output sequence, processing the target output sequence using the neural network to generate a network output that includes respective score distributions over the vocabulary of output tokens for the output positions in the target output sequence; and training each gating sub-layer using respective rewards for the gating sub-layer for the output positions through reinforcement learning to optimize a reinforcement learning objective function that measures an expected reward received by the gating sub-layer.

### CROSS-REFERENCE TO RELATED APPLICATION

This application claims priority to U.S. Provisional Application No. 63/286,923, filed on Dec. 7, 2021. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that trains a neural network having one or more conditional computation layers using reinforcement learning.

According to a first aspect there is provided a method performed by one or more data processing apparatus for training a neural network having one or more conditional computational layers, wherein each conditional computation layer comprises (i) a gating sub-layer comprising a plurality of gating parameters and (ii) an expert sub-layer comprising a plurality of expert neural networks, to perform a machine learning task, the method comprising: sampling a batch of training examples, wherein each training example includes a network input and a respective target output sequence that comprises a respective ground truth output token at each of a plurality of output positions, wherein each ground truth output token is selected from a vocabulary of output tokens; for each training example, processing the network input using the neural network to generate a network output that includes for each of the plurality of output positions in the target output sequence a respective score distribution over the vocabulary of output tokens, comprising: for each of the one or more conditional computation layers: receiving a layer input sequence for the conditional computation layer that is generated from at least the network input and that comprises a respective layer input for each of the plurality of output positions; processing each layer input of the layer input sequence using the gating sub-layer and in accordance with current values of the gating parameters to generate a respective set of gating scores for each layer input; for each layer input: selecting an expert neural network from the plurality of expert neural networks in the expert sub-layer based at least in part on the respective set of gating scores for the layer input; and processing the layer input using the respective selected expert neural network to generate a respective expert output for the layer input; and generating a layer output sequence for the conditional computation layer from the expert outputs for the layer inputs; for each gating sub-layer and for each output position in each of the target output sequences, generating a reward for the gating sub-layer for the output position from at least a respective score assigned to the ground truth output token at the output position by the score distribution generated by the neural network for the output position; and training each of the gating sub-layers using the respective rewards for the gating sub-layer for the output positions through reinforcement learning to optimize a reinforcement learning objective function that includes one or more terms that measure an expected reward received by the gating sub-layer.

In some implementations, the method further comprises training the selected experts on a supervised learning objective that measures for each output position in each training network output an error between (i) the score distribution generated by the neural network for the output position and (ii) a respective ground truth score distribution based on the ground truth output token at the output position by backpropagating gradients of the supervised learning objective through the neural network.

In some implementations, for each gating sub-layer the expected reward received by the gating sub-layer for a given output position in a given target output sequence is a time discounted sum of the respective rewards for the gating sub-layer for the output positions equal to and any output positions that are after the given output position. Specifically, for each output position in a target output sequence (a “current” output position), a corresponding expected reward for the gating sub-layer and the target output sequence can be generated. The expected reward includes, in addition to the reward for the output position, a respective reward for each of the “future” output positions of the target output sequence which are later than the current output position, discounted by a factor which decreases according to the respective number of positions between the future output position and the current output position (e.g., the factor may be a discount factor raised to the power of this number of positions).

In some implementations, the reinforcement learning objective function further comprises an entropy term that measures an entropy of the layer input to expert neural network assignments for the layer inputs in the batch. The “the layer input to expert neural network assignment” for a given layer input in the batch refers to the selected expert neural network for the given layer input. Thus, the entropy of “the layer input to expert neural network assignments” refers to the entropy in the (distribution of) selected expert neural networks for the layer inputs in the batch.

In some implementations, the entropy term measures a Shannon Entropy of the layer input to expert neural network assignments.

In some implementations, selecting an expert neural network from the expert sub-layer based at least in part on the respective set of gating scores for each layer input comprises: processing the respective sets of gating scores for the layer inputs using a gating function to generate a respective set of assignation scores for each layer input; and selecting an expert neural network for each layer input based at least in part on the respective assignation scores for the layer input.

In some implementations, selecting an expert neural network for each layer input based at least in part on the respective assignation scores for the layer input comprises: selecting the expert neural network for the layer input corresponding to the largest assignation score for the layer input.

In some implementations, the gating function is an optimal transport function.

In some implementations, the gating function is a Sinkhorn algorithm.

In some implementations, generating a layer output for each conditional computation layer from the respective expert outputs for the conditional computation layer for the layer inputs comprises concatenating the respective expert outputs for the conditional computation layer for the layer inputs.

In some implementations, for each of the one or more expert sub-layers, the plurality of expert neural networks in the expert sub-layer are distributed across one or more respective computational devices.

In some implementations, the method further comprises using the neural network to perform the machine learning task after the neural network has been trained to perform the machine learning task.

In some implementations, after the neural network has been trained to perform the machine learning task, performing the machine learning task by processing a network input using the neural network to generate a network output that includes for each of a plurality of output positions in the network output a respective score distribution over the vocabulary of output tokens comprises: for each of the one or more conditional computation layers: receiving a layer input sequence that is generated from the network input for the conditional computation layer and that comprises one or more layer inputs; processing each layer input of the layer input sequence using the gating sub-layer and in accordance with current values of the gating parameters to generate a respective set of gating scores; for each layer input: selecting an expert neural network from the expert sub-layer based at least in part on the respective set of gating scores for the layer input; and processing the layer input using the respective selected expert neural network to generate a respective expert output for the layer input; and generating a layer output for the conditional computation layer from the expert outputs for the one or more layer inputs.

In some implementations, selecting an expert neural network from the expert sub-layer based at least in part on the respective set of gating scores for each layer input comprises: selecting the expert neural network for each layer input corresponding to the largest gating score for the layer input.

In some implementations, the method further comprises, for each output position in the network output: selecting an output token for the output position from the vocabulary of output tokens in accordance with the respective score distribution for the output position.

In some implementations, selecting an output token for the output position from the vocabulary of output tokens in accordance with the respective score distribution for the output position comprises: selecting the output token from the vocabulary of output tokens that corresponds to the largest score in the respective score distribution for the output position.

In some implementations, selecting an output token for the output position from the vocabulary of output tokens in accordance with the respective score distribution for the output position comprises: sampling the output token from the vocabulary of output tokens in accordance with the respective score distribution for the output position.

In some implementations, the neural network autoregressively generates the output tokens in the network output by processing a combined sequence comprising at least a concatenation of the network input and any output tokens at output positions in the network output preceding the output token.

In some implementations, there is provided a method performed by one or more data processing apparatus, the method comprising: processing a network input using a neural network to generate a network output that includes for each of a plurality of output positions in the network output a respective score distribution over the vocabulary of output tokens, wherein the neural network includes one or more conditional computational layers, wherein each conditional computation layer comprises (i) a gating sub-layer comprising a plurality of gating parameters and (ii) an expert sub-layer comprising a plurality of expert neural networks, and wherein the neural network has been trained using the respective operations of any implementation above.

In some implementations, there is provided a system comprising: one or more computers; and one or more storage devices storing instructions that, when executed by the one or more computers, cause the one or more computers to implement: a neural network that is configured to process a network input using a neural network to generate a network output that includes for each of a plurality of output positions in the network output a respective score distribution over the vocabulary of output tokens, wherein the neural network includes one or more conditional computational layers, wherein each conditional computation layer comprises (i) a gating sub-layer comprising a plurality of gating parameters and (ii) an expert sub-layer comprising a plurality of expert neural networks, and wherein the neural network has been trained using the respective operations of any of the above implementations.

An alternative expression of the first aspect is a method performed by one or more data processing apparatus for training a neural network having one or more conditional computational layers, wherein each conditional computation layer comprises (i) a gating sub-layer comprising a plurality of gating parameters and (ii) an expert sub-layer comprising a plurality of expert neural networks, to perform a machine learning task, each gating sub-layer being configured to select one of the expert neural networks based on a layer input to the conditional computational layer, and each expert sub-layer being operative to generate an expert output from a layer input to the conditional computational layer, the method comprising: sampling a batch of training examples, wherein each training example includes a network input and a respective target output sequence that comprises a respective ground truth output token at each of a plurality of output positions, wherein each ground truth output token is selected from a vocabulary of output tokens; for each training example, processing the network input using the neural network to generate a network output that includes for each of the plurality of output positions in the target output sequence a respective score distribution over the vocabulary of output tokens, the processing of the network input comprising: (i) for each of the one or more conditional computation layers: receiving a layer input sequence for the conditional computation layer that is generated from at least the network input and that comprises a respective layer input for each of the plurality of output positions; processing each layer input of the layer input sequence using the gating sub-layer and in accordance with current values of the gating parameters to generate a respective set of gating scores for each layer input; for each layer input: selecting an expert neural network from the plurality of expert neural networks in the expert sub-layer based at least in part on the respective set of gating scores for the layer input; and processing the layer input using the respective selected expert neural network to generate a respective expert output for the layer input; and generating a layer output sequence for the conditional computation layer from the expert outputs for the layer inputs; (ii) generating the respective score distribution for each of the plurality of output positions from the layer output sequence for one of the conditional computation layers; for each gating sub-layer and for each output position in each of the target output sequences, generating a reward for the gating sub-layer for the output position from at least a respective score assigned to the ground truth output token at the output position by the score distribution generated by the neural network for the output position; and updating each of the gating sub-layers using the respective rewards for the gating sub-layer for the output positions to optimize a reinforcement learning objective function that includes one or more terms that measure an expected reward for the gating sub-layer.

If there are multiple conditional computational layers, they may be in a sequence (optionally with other layers interleaved with the sequence), and the respective score distributions may be generated from the layer output of the last conditional computational layer in the sequence, e.g., directly from the layer output or by processing the layer output through one or more neural network layers.

The “expected reward” term may just be based on the rewards for the output positions for each of the training examples, or it may additionally include, for each output position in each of the training examples, terms based on rewards for future output positions, e.g., discounted by the number of positions between the output position for the reward and the future output positions.

Particular embodiments of the subject matter described in this specification can be implemented so as to realize one or more of the following advantages.

The system described in this specification trains a neural network that has one or more conditional computation layers to perform a machine learning task. Each conditional computation layer has (i) a gating sub-layer having multiple gating parameters and (ii) an expert sub-layer having multiple expert neural networks.

To train the neural network to perform the machine learning task, at each training iteration, the system samples a batch of training examples, where each training example includes a target output sequence that includes a respective ground truth output token at each of multiple output positions. Each ground truth output token is selected from a vocabulary of output tokens. For each target output sequence in the sampled batch, the system uses the neural network to process the target output sequence to generate a network output that includes for each output position in the target output sequence a respective score distribution over the vocabulary of output tokens. To generate the network output, the neural network, for each conditional computation layer, receives a layer input sequence that is generated from the target output sequence and has a respective layer input for each output position in the target output sequence. The conditional computation layer processes each layer input using the gating sub-layer to generate a respective set of gating scores for the layer input, and selects an expert neural network from the expert sub-layer for the layer input based at least in part on the gating scores for the layer input. The conditional computation layer processes each layer input using the respective selected expert neural network for the layer input to generate an expert output for the layer input. Then, the conditional computation layer generates a layer output from the expert outputs for the conditional computation layer. The system generates a respective reward for each gating sub-layer and for each layer input based on the score distributions for each output position in the target output sequence. The system trains each gating sub-layer using the respective rewards for the gating sub-layer using reinforcement learning to optimize a reinforcement learning objective function. That is, the training uses any appropriate reinforcement learning algorithm (any known algorithm or any algorithm proposed in the future) which trains an adaptive system based on rewards generated based on outputs of the adaptive system when corresponding inputs are processed by the adaptive system. The reinforcement learning objective function is based on those rewards. Using reinforcement learning to train the gating sub-layers of the neural network can enable the neural network to generate more accurate network outputs than more conventional training methods. That is, using reinforcement learning can enable the neural network to generate network outputs that better match the target output sequences a higher percentage of the time. Additionally, using reinforcement learning can enable the neural network to better generalize (e.g., achieve better performance for examples not in the training data) when generating network outputs.

The gating sub-layers can, especially early during training, generate highly uneven layer input to expert neural network assignments, where some of the expert neural networks receive many layer input assignments and some receive very few. Highly uneven layer input to expert neural network assignments can cause a self-reinforcing problem where expert neural networks that receive many training examples achieve better performance and therefore receive even more layer input assignments. In order to solve the issue, the system can use a load balancing function to encourage more evenly distributed (“load balanced”) layer input to expert neural network assignments.

In some cases, the system can use a Sinkhorn algorithm to process the set of gating scores for each layer input and to generate a set of assignation scores for each layer input. The system can select an expert neural network for each layer input from the corresponding expert sub-layer for the gating sub-layer based on the assignation scores for the layer input. Using the assignation scores to select a respective expert neural network for each layer input can enable the system to more evenly redistribute the layer inputs across the expert neural networks in the expert sub-layer. Redistributing the layer inputs across the expert neural networks in the expert sub-layer can enable the system to generate a better balanced distribution, so that each expert neural network receives an approximately more equal number of layer inputs as compared with conventional systems which do not use a Sinkhorn algorithm. In particular, early in training when the gating sub-layer has undergone few training iterations and therefore the layer input to expert neural network assignments are likely to be highly uneven, the Sinkhorn algorithm can enable the system to redistribute the layer inputs more evenly across the expert neural networks. More evenly distributing the layer inputs across the expert neural networks, particularly early in training, can enable the system to train the neural network more efficiently (e.g., using fewer training iterations) and using fewer computation resources (e.g., memory and FLOPS).

In some cases the expert neural networks for each expert sub-layer can be distributed across multiple computational devices, where each computational device has a respective amount of memory to store the layer inputs, e.g., devices that use central processing units (“CPUs”), graphical processing units (“GPUs”), or application-specific integrated circuits (“ASICs”). Unevenly balanced layer input to computational device assignments can lead to some computational devices receiving a number of layer inputs that exceeds the amount of memory available on the computational device to store data associated with the layer. Exceeding the available memory on a computational device can cause the computational device to “drop” one or more of the layer inputs. That is, exceeding the available memory on a computational device can cause the computational device to assign a default value to the corresponding expert output instead of computing the expert output, e.g., assign the original value of the layer input without performing the processing of the layer, which can result in the system losing computational efficiency. More evenly redistributing the layer inputs for each target output sequence using a Sinkhorn algorithm can enable the system to drop fewer layer inputs. Dropping fewer layer inputs can enable the system to train the neural network using fewer training iterations, and therefore fewer computational resources (e.g., FLOPS and memory).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a block diagram of an example conditional computation layer.

FIG. 3 is a flow diagram of an example process for training a neural network having one or more conditional computation layers.

Like reference numbers and designations in the various drawings indicate like elements.

### DETAILED DESCRIPTION

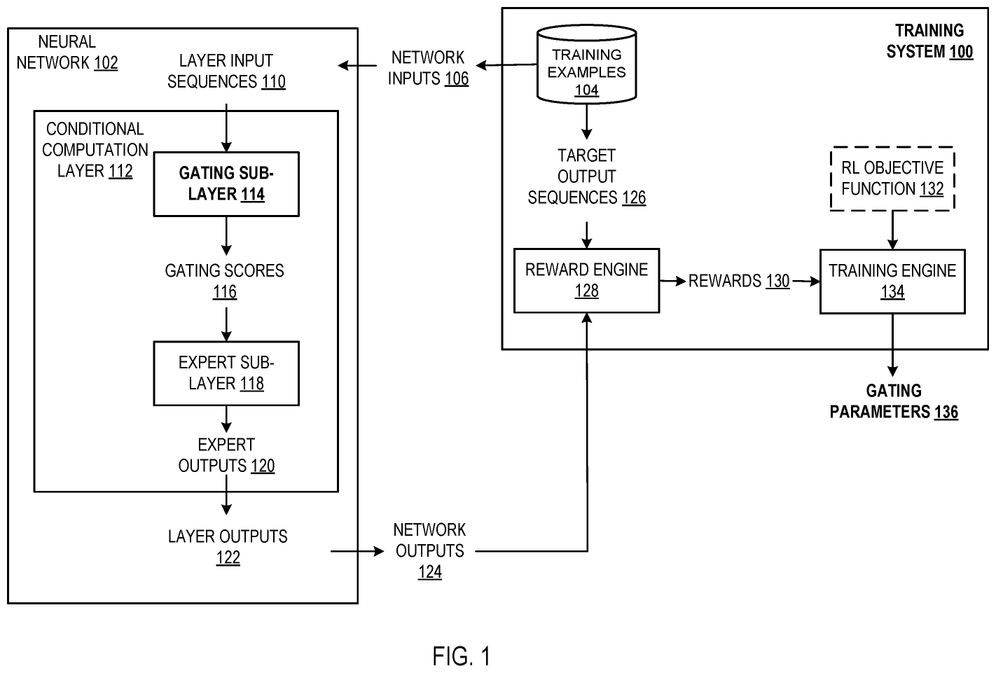

FIG. 1 shows an example training system 100. The training system 100 is an example of a system implemented as computer programs on one or more computers in one or more locations in which the systems, components, and techniques described below are implemented.

The training system 100 trains a neural network 102 having one or more conditional computation layers (e.g., conditional computation layer 112) to perform a machine learning task. Although, as illustrated in FIG. 1, the neural network 102 includes only a single conditional computational layer, it is to be understood that the neural network may include multiple such layers, and/or in addition one or more layers of other types. For example, the neural network 102 may be any known neural network with one or more conditional layers inserted into it.

After being trained, the neural network 102 can be configured to generate an output sequence conditioned on a network input. The output sequence can include at each of one or more output positions in the output sequence a respective output token from a vocabulary of output tokens.

The neural network 102 can be configured to generate any of a variety of types of output sequences, i.e., to perform any of a variety of types of machine learning tasks.

The neural network can be configured to generate the output sequence conditioned on any appropriate network input. The network input can include one or more input tokens from a vocabulary of input tokens, e.g., only start token for an unconditioned output sequence. For example, the vocabulary of input tokens can include input tokens representing characters (e.g., letters, or pictograph characters), word fragments, words, special separator and punctuation tokens, etc. In one example, the input tokens can represent characters, word fragments, and words from human languages (e.g., English, Korean, etc.). In another example, each input token can represent a code symbol from a vocabulary of code symbols, e.g., from coding languages, such as C, C++, Python, etc. In yet another example, the input tokens can represent other symbols imbued with semantic meaning in a consistent manner.

In one example, the neural network can be part of an automatic medical diagnostic system. The network input can characterize input from a user detailing the health of the user, and the output sequence can represent a medical diagnosis for the user, e.g., where each output token is selected from a vocabulary of text-related tokens (e.g., characters, word fragments, etc., as described above), medical diagnostic code tokens (e.g., representing an alphanumerical medical diagnostic code that corresponds to a respective medical diagnosis), or both. For example, the user input can include current health symptoms, pre-existing conditions, medications, and so on. The output sequence can be generated as part of a conversation with the user relating to the user's health.

In another example, the network input can include a text sequence, and the target output sequence can include a corresponding summary of the text sequence.

In another example, the output sequence can characterize a song, where each output token represents a musical symbol from a vocabulary of musical symbols (e.g., different notes, different length rests, etc.), and the neural network can be part of a music generation system. The network input can be, e.g., the first few notes of the song.

In another example, the output sequences can include a text sequence that represents a narrative story, and the neural network can be part of a story generation system.

In another example, the task can be a neural machine translation task. For example, if the network input to the neural network is a sequence of text, e.g., a sequence of words, phrases, characters, or word pieces, in one language, the output sequence generated by the neural network can be a translation of the sequence of text into another language, i.e., a sequence of text in the other language that is a translation of the input sequence of text. As a particular example, the task can be a multi-lingual machine translation task, where a single neural network is configured to translate between multiple different source language—target language pairs. In this example, the source language text can be augmented with an identifier that indicates the target language into which the neural network should translate the source language text.

In another example, the task can be a speech recognition task. For example, if the network input to the neural network is a sequence representing a spoken utterance (e.g., a sequence of data elements representing corresponding sound signals captured by a microphone at a sequence of corresponding successive times), the output sequence generated by the neural network can be a sequence of text in a natural language that is a transcription of the spoken utterance in the natural language. In this case the output tokens may be respective characters of an alphabet (e.g., the Roman alphabet) or punctuation marks.

In another example, the task can be a text generation task, where the network input is a sequence of text, and the output sequence is another sequence of text, e.g., a completion of the input sequence of text, a response to a question posed in the input sequence, or a sequence of text that is about a topic specified by the first sequence of text. As another example, the network input to the text generation task can be an input other than text, e.g., an image (e.g., an image of part the real world captured by a camera), and the output sequence can be text that describes the network input. As yet another example, the network input to the text generation task can be a placeholder input and the system can generate the output sequence conditioned on the placeholder input, i.e., the task is an unconditional task generation task.

In another example, the task can be a response generation task, where the network input can include an input prompt of a user, and the output sequence can represent a response to the input prompt of the user. For example, the neural network can be a part of a chat bot, and the user can be interacting with the chat bot to receive answers to questions, e.g., a customer service chat bot for a company, or an interactive FAQ bot for addressing in a dynamic manner the most frequently asked questions for a company or service.

In another example, the task can be an image generation task, where the network input is a conditioning input (e.g., in the form of text, or sound captured by a microphone from a user speaking) and the output sequence is a sequence of intensity value inputs for the pixels of an image. In this case, the output tokens may be respective allowed (discrete) intensity values for a given one of the pixels (or groups of the pixels).

In another example, the task can be a computer code generation task and the neural network generates output sequences that represent sequences of computer code (e.g., in a computer programming language). In some implementations, the task can involve receiving, as the network input, a natural language description of desired computer code, and in response, generating a sequence of computer code that fits the natural language description of the desired computer code. In some implementations, the task can involve receiving a network input that is an input sequence of computer code, and in response, generating a output sequence of computer code that is a completion of the input sequence of computer code (e.g., that logically extends the input sequence of computer code).

The above examples of input token and output token vocabularies should not be understood as exhaustive. Generally, a token vocabulary can be a set of any appropriate kind of tokens, and the tokens are not limited to the above examples.

At inference, the neural network 102 generates an output sequence by generating a network output (e.g., network outputs 124) that includes, for each output position in the output sequence, a respective score distribution for the output position and then selecting an output token for the output position, e.g., by sampling the output token in accordance with the respective score distribution, or by selecting the output token corresponding to the largest score in the score distribution.

In cases where the generation is autoregressive, the system can generate the score distribution at each output position conditioned on the network input (e.g., network inputs 106) and any output tokens before that output position in the output sequence. The neural network may, for example, be an (autoregressive) transformer decoder, such as one used in some known large learning models (LLM) but modified to include one or more conditional computational layers. For example, when the neural network 102 is a transformer decoder with masked self-attention, the training system 100 can process a combined sequence that includes the network input and any output tokens already generated in the output sequence to generate the respective score distribution.

The neural network 102 can process the network input using one or more conditional computation layers to generate the corresponding output sequence, e.g., conditional computation layer 112. Each conditional computation layer is configured to receive a corresponding layer input sequence that is generated from the network input (e.g., layer input sequences 110) and to generate a respective layer output corresponding to the layer input sequence (e.g., layer outputs 122). The layer input sequence can include a respective layer input for each output position in the corresponding output sequence, where each layer input is represented by, e.g., a collection of ordered numerical values, such as a vector or matrix of numerical values.

For example, if the neural network 102 is a transformer decoder, the conditional computation layers can be in one or more of the attention blocks, e.g., replacing the position-wise feedforward neural network layers. More generally, the conditional computation layers can be inserted in any appropriate location, e.g., between any two neural network layers, in any neural network that generates an output sequence. Optionally, multiple conditional computation layers may be arranged in a sequence, optionally with other neural network layers interspersed among the conditional computation layers in the sequence and with each layer but the first in the sequence configured to receive an output of the preceding layer in the sequence.

Each conditional computation layer includes a gating sub-layer that has multiple respective gating parameters and an expert sub-layer that has multiple respective expert neural networks, as are described in more detail below. For convenience, a single conditional computation layer, e.g., conditional computation layer 112 including gating sub-layer 114 and expert sub-layer 118, is described below.

The gating sub-layer 114 is configured to process the layer input sequence in accordance with the gating parameters to generate a respective set of gating scores for each layer input in the layer input sequence. Each gating score in the set of gating scores can represent an affinity of the layer input for a respective expert neural network in the expert sub-layer, and can be represented by, e.g., a numerical value. Based at least in part on the gating scores for each layer input, the conditional computation layer selects an expert neural network in the expert sub-layer to process the layer input, e.g., by selecting the expert neural network corresponding to the largest gating score or by sampling the expert neural network in accordance with the gating scores.

The expert sub-layer 118 is configured to process each layer input using the respective selected expert neural network to generate an expert output for the layer input (e.g., expert outputs 120). For example, each expert output can be represented by a collection of numerical values, such as a vector or matrix of numerical values.

In some cases, the expert neural networks for the expert sub-layer 118 can be stored on a single computational device, so that the computations for generating the expert outputs are local to the computational device, e.g., devices that use central processing units (“CPUs”), graphical processing units (“GPUs”), or application-specific integrated circuits (“ASICs”).

In some cases, there can be a large number of expert neural networks, so that the expert neural networks for a single expert sub-layer cannot be feasibly deployed on a single computational device, e.g., because the neural network parameters of all of the expert neural networks cannot fit in memory of the computational device, generating network outputs using all the expert neural networks selected for all of the layer inputs will cause excessive latency, or both. In this case, the expert neural networks for the expert sub-layer 118 can be distributed across multiple computation devices, e.g., central processing units, graphics processing units, other ASICS, or some combination, so that the computations are distributed across the multiple computational devices.

The conditional computation layer 112 processes the expert outputs 120 for the layer input sequence to generate the respective layer output (e.g., layer outputs 122). Each layer output can be represented by, e.g., a collection of ordered numerical values, such as a vector or matrix of numerical values. For example, the conditional computation layer can process the expert outputs for the layer input sequence to generate a sequence that includes at each position in the corresponding layer input sequence the expert output generated for the layer input at that position.

The neural network 102 processes the layer output to generate the respective network output (e.g., network outputs 124). The network output can include a respective score distribution over the vocabulary of output tokens and for each output position in the corresponding output sequence. For example, the neural network 102 can include subsequent neural network layers after the final conditional computation layer to process each layer output to generate a respective network output.

At inference (i.e. following the training process described below), the neural network 102 can further process the network output to select an output token for each output position in the output sequence, e.g., by sampling the output token in accordance with the respective score distribution for the output position, or by greedily sampling the output token by selecting the output token corresponding to the largest gating score.

The neural network 102 can include any appropriate subsequent neural network layers that enables it to perform its described function, i.e., processing each layer output from the final conditional computation layer to generate a respective network output including a respective score distribution over a vocabulary of output tokens and for each output position in the corresponding target output sequence. In particular, the neural network can include any appropriate types of neural network layers (e.g., fully-connected layers, attention-layers, convolutional layers, etc.) in any appropriate numbers (e.g., 1 layer, 5 layers, or 25 layers), and connected in any appropriate configuration. In a particular example, the neural network can include a subsequent attention neural network layer followed by a fully-connected neural network layer with a softmax function.

The training system 100 can train the neural network 102 by updating the neural network parameters of the neural network 102 at each of multiple training iterations. At each training iteration, the training system 100 can sample a batch of training examples, where each training example includes a respective target output sequence (e.g., target output sequences 126) and a network input that should be processed by the neural network 102 to generate the target output sequence (e.g., network inputs 106). The training system 100 can process each network input using the neural network 102 to generate a respective network output (e.g., network outputs 124), and update the neural network parameters based on the network outputs. For convenience, the training system is described below for a single training iteration.

The training system 100 samples the batch of training examples from a set of training examples 104. The set of training examples 104 includes multiple training examples, where each training example includes a network input and a corresponding target output sequence. Each target output sequence contains a respective ground truth output token at each of multiple output positions, where each ground truth output token is selected from a vocabulary of output tokens. For example, the target output sequence can represent a text sequence, and each output token can represent a character, a sub-word, a word, or a special token (e.g., a separate token, or a punctuation token) in the text sequence.

During training, the training system 100 can process each network input of the network inputs 106 using neural network 102 to generate a respective network output, e.g., network outputs 124, that includes a respective score distribution for each output position in the corresponding target output sequence. Optionally, the neural network 102 can further process the respective score distribution for each output position to select an output token for the output position, e.g., by sampling the output token in accordance with the score distribution, or by selecting the output token corresponding to the largest score.

During training, the neural network 102 process the network inputs 106 to generate the layer input sequences 110 for one or more conditional computation layers in the neural network 102, as described above for during inference. For convenience, a single conditional computational, e.g., conditional computation layer 112, is described below.

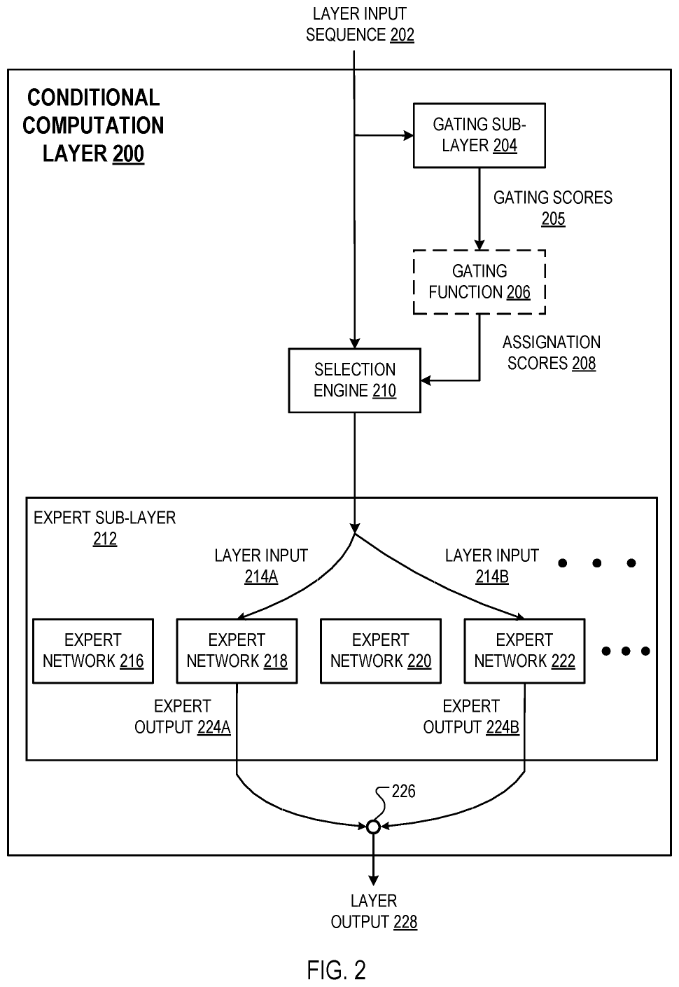

During training, gating sub-layer 114 can process each layer input sequence in accordance with the gating parameters to generate a respective set of gating scores for each layer input in the layer input sequence. Based at least in part on the gating scores for each layer input, the conditional computation layer 112 selects an expert neural network in the expert sub-layer 118 to process the layer input. For example, the training system 100 can process the sets of gating scores for the layer inputs during training using a gating function to select an expert neural network in the expert sub-layer for each layer input, as is described in further detail with reference to FIG. 2 below. In another example, the training system 100 can select the expert neural networks directly using the gating scores, e.g., by selecting the expert neural network corresponding to the largest gating score, or by sampling the expert neural network in accordance with the respective set of gating scores.

During training, the expert sub-layer 118 processes each layer input using the respective selected expert neural network to generate an expert output for the layer input, e.g., expert outputs 120. For example, each expert output can be represented by a collection of numerical values, such as a vector or matrix of numerical values.

During training, for each layer input sequence of the layer input sequences 110, the conditional computation layer 112 processes the expert outputs 120 for the layer input sequence to generate the respective layer output, e.g., layer outputs 122. For example, for each layer input sequence, the conditional computation layer can process the expert outputs for the layer input sequence to generate a sequence that includes at each position in the corresponding layer input sequence the expert output generated for the layer input at that position.

During training, the neural network 102 processes each layer output of the layer outputs 122 to generate the respective network output in the network outputs 124. Each network output can include a respective score distribution over the vocabulary of output tokens and for each output position in the corresponding target output sequence. For example, the neural network 102 can include subsequent neural network layers after the final conditional computation layer to process each layer output to generate a respective network output.

In some cases, the neural network 102 can further process each network output to select an output token for each output position in the target output sequence, e.g., by sampling the output token in accordance with the respective score distribution for the output position.

The training system 100 trains the gating sub-layers by using a reinforcement learning technique and, optionally, the rest of the neural network (e.g., including the expert neural networks in each expert sub-layer) using a supervised learning technique.

The training system 100 includes a reward engine 128 and a training engine 134 to train each of the one or more gating sub-layers in the neural network 102 by updating gating parameters of the gating sub-layer using a corresponding reinforcement learning objective function. For convenience, the training system 100 updating the gating parameters of a single gating sub-layer, e.g., gating parameters 136 of gating sub-layer 114, is each described below.

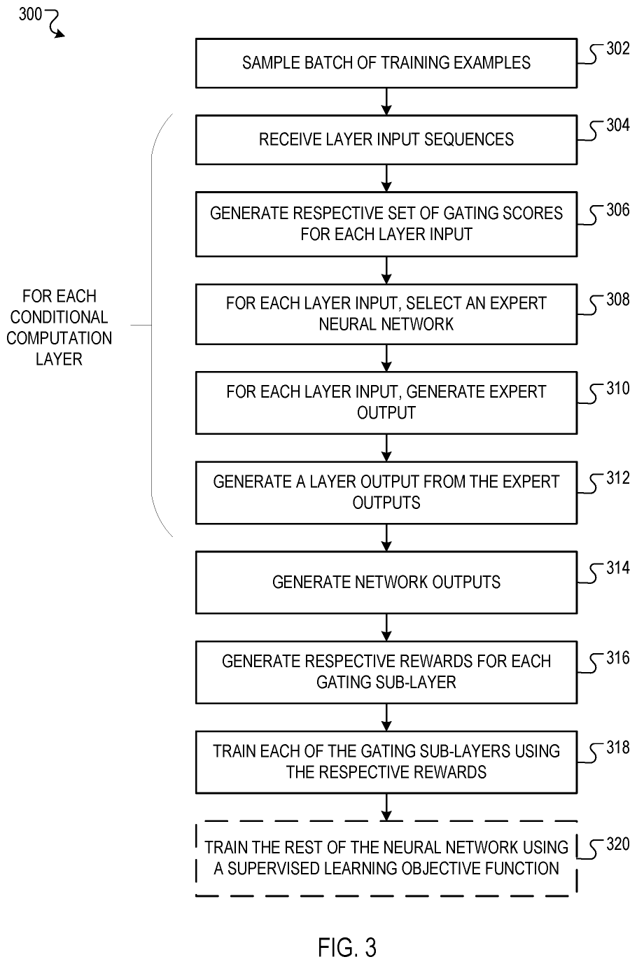

The reward engine 128 is configured to process each network output and the corresponding target output sequence to generate respective rewards for the gating sub-layer 114, e.g., rewards 130. For example, the reward engine 128 can generate a respective reward for each output position in the target output sequence, as is described in further detail with respect to FIG. 3.

The training engine 134 is configured to update the gating parameters 136 by applying a policy gradient algorithm to optimize a reinforcement learning (RL) objective function 132. The RL objective function 132 can measure an expected reward for the gating sub-layer 114 that is generated from the rewards 130. For example, the training system 100 can use the REINFORCE policy gradient algorithm to update the gating parameters 136, as is described in further detail with respect to FIG. 3.

Using reinforcement learning to train the gating sub-layers of the neural network can enable the neural network to generate more accurate network outputs than more conventional training methods. That is, using reinforcement learning can enable the neural network to generate network outputs that better match the target output sequences a higher percentage of the time. Additionally, using reinforcement learning can enable the neural network to better generalize (e.g., achieve better performance for examples not in the training data) when generating network outputs.

The RL objective function 132 can optionally include an entropy term to encourage load balancing across the respective expert neural networks in each expert sub-layer. The entropy term can discourage the gating sub-layer from assigning too many layer inputs to any one expert neural network in the expert sub-layer, and encourage the gating sub-layer to distribute the layer input assignments more evenly across the expert neural networks in the expert sub-layer. For example, the entropy term can measure a Shannon entropy of the layer input to expert neural network assignments, as is described in further detail with respect to FIG. 3.

More evenly distributing the layer input to expert neural network assignments can help ensure that the training system 100 provides each of the expert neural networks with enough layer inputs to properly train the expert neural network. Additionally, in cases where the expert neural networks are distributed across multiple computational devices, encouraging load balancing can help ensure that the memory capacity of each computational device is not exceeded (e.g., resulting in “dropped” computations) and can help reduce excessive latency from bottlenecking (e.g., computational devices waiting on the results of other computations). Reducing dropped computations and bottlenecking can increase the efficiency of training the neural network, so that the training is completed with fewer training iterations and consumes fewer computational resources (e.g., memory, or FLOPS).

The training system can train the rest of the neural network 102 (e.g., the expert neural networks in each expert sub-layer) using supervised learning techniques. The system can update the neural network parameters of the rest of the neural network 102 by determining a gradient of a supervised objective function for each training example (e.g., using backpropagation), and applying the gradients to update the neural network parameter values of the neural network system using an appropriate gradient descent optimization technique, e.g., RMSprop or Adam. For example, for each network output, the objective function can be a cross-entropy objective function, as is discussed in further detail with respect to FIG. 3.

FIG. 2 shows an example conditional computation layer 200. The conditional computation layer 200 is an example of a system implemented as computer programs on one or more computers in one or more locations in which the systems, components, and techniques described below are implemented.

The conditional computation layer 200 processes layer input sequence 202 to generate a layer output 228 characterizing the layer input sequence 202. The layer input sequence 202 can be generated from a network input and can include a respective layer input for each output position in a target output sequence corresponding to the network input. For example, each layer input can be represented by a collection of ordered numerical values, such as a vector or matrix of numerical values.

During training, the conditional computation layer 200 can process multiple layer input sequences for each of multiple training iterations, e.g., multiple layer input sequences corresponding to a sampled batch of training examples for each training iteration, as described in FIG. 1 above. For convenience, the conditional computation layer 200 is described below for a single layer input sequence, e.g., layer input sequence 202.

During training, the conditional computation layer 200 includes a gating sub-layer 204 that has multiple gating parameters, a selection engine 210, an expert sub-layer 212 that includes one or more expert neural networks, a combination function 226, and, optionally, a gating function 206.

The gating sub-layer 204 is configured to process the layer inputs in the layer input sequence 202 to generate a respective set of gating scores 205 for each layer input. The respective set of gating scores for each layer input includes a respective gating score for each expert neural network in the expert sub-layer 212. The respective gating score for each expert neural network can indicate an affinity of the layer input for the expert neural network. The gating sub-layer 204 contains multiple gating parameters and generates the respective gating scores for each layer input in accordance with the gating parameters.

For example, the gating parameters of the gating sub-layer 204 can include a learned vector for each expert neural network, and can generate a respective initial score for each expert neural network by computing a dot product between the learned vector for the expert neural network and the layer input. The gating sub-layer 204 can compute the respective gating scores for the layer input by applying a softmax function to the initial scores.

In cases where the conditional computation layer 200 is configured without including a gating function 206, the selection engine 210 can assign each layer input to a respective expert neural network in the expert sub-layer 212 directly using the gating scores (e.g., selecting the expert neural network corresponding to the largest gating score, or by sampling the expert neural network in accordance with the gating scores).

In cases where the conditional computation layer 200 includes the gating function 206, the gating function 206 can be configured to process the gating scores 205 for the layer inputs and to generate a respective set of assignation scores for each layer input. The respective set of assignation scores for each layer input can include a respective assignation score for each expert neural network in the expert sub-layer 118. Each assignation score can represent an updated affinity of the layer input for the respective expert neural network that encourages load balancing across the expert neural networks. Processing the gating scores 205 using the gating function can encourage the conditional computation layer 200 to more evenly distribute the layer inputs in the layer input sequence 202 across the expert neural networks in the expert sub-layer 212.

For example, the gating function 206 can apply a Sinkhorn algorithm to the gating scores 205 to generate the assignation scores. The Sinkhorn algorithm maps each layer input to an expert neural network in accordance with the respective gating scores for the layer input (i.e., to an expert neural network corresponding to a large gating score) while also load balancing the layer inputs across the expert neural networks (i.e., assigning an approximately equal number of layer inputs to each expert neural network). That is, the Sinkhorn algorithm attempts to maximize the affinity of each layer input (e.g., assign the layer input to an expert neural network corresponding to a large gating score) while helping to ensure that each layer input is assigned to an expert neural network and that each expert neural network is assigned the same number of layer inputs.

More formally, the Sinkhorn algorithm attempts to find a transport matrix such that each row in the transport matrix includes the respective set of assignation scores for a corresponding layer input, where each row sums to one (i.e., so that the assignation scores for each layer input sum to one) and each column sums to the total number of layer inputs divided by the total number of expert neural networks. To find the transport matrix, the Sinkhorn algorithm attempts to minimize a distance between an affinity matrix, e.g., a matrix composed of the respective gating scores for each layer input, where each respective set of gating scores is arranged as a row in the matrix, and the transport matrix, as

$${π}^{*} = {min}_{πϵ U ( α , β )} 〈 C , π 〉 , \qquad ( 1 )$$

where C represents the affinity matrix, π* represents the optimal transport matrix, (C, π) represents the Kantorovich distance (or “Wasserstein metric”) between C and π, and π represents a transport matrix that satisfies constraints defined by U (α, β), represented as

U(α,β)={πϵM₁⁺(X*Y),π1=π,π^{T}=β} (2)

where α represents a vector of all ones and of dimension equal to the total number of layer inputs (i.e., π1 represents the constraint that each set of assignation scores must sum to one), β represents a vector of dimension equal to the total number of expert neural networks and with all entries equal to the total number of layer inputs divided by the total number of expert neural networks (i.e., π^{T}1 represents the constraint that each expert neural network should be assigned the same number of layer inputs, e.g., the total number of layer inputs divided by the total number of expert neural networks), and πϵM₁⁺(X*Y) indicates that π is selected from a space of transportation plans from space

X={1, . . . ,number of layer inputs}, (3)

to space

Y={1, . . . ,number of expert neural networks}. (4)

The minimization problem of equation (1) can be solved using any appropriate technique, e.g., a network simplex algorithm, and equation (2) can be solved using the Sinkhorn algorithm.

Processing the gating scores with a Sinkhorn algorithm during training can enable the system to more evenly balance the layer inputs across the expert neural networks in the expert sub-layer 214, which can help ensure that each expert neural network receives a sufficient number of layer inputs to be trained. In particular, early in training when the gating sub-layer 204 has undergone few training iterations, redistributing the layer inputs more evenly across the expert neural networks in the expert sub-layer 214 can enable a training system, e.g., the training system 100 of FIG. 1, to train the conditional sub-layer in fewer training iterations, thereby saving computational resources (e.g., memory and FLOPS).

In cases where the expert neural networks are distributed across multiple computational devices, the Sinkhorn equation can be modified so that the load balancing is performed across the computational devices instead of across the expert neural networks directly. That is, the constraint that each expert neural network should receive an approximately equal number of layer inputs can be changed to a constraint that each computational device should receive an equal number of layer inputs, e.g., the total number of layer inputs divided by the total number of computational devices. The respective set of assignation scores can include a respective assignation score for each computational device, so that a computational device is selected for each layer input in accordance with the assignation scores, e.g., by selecting the computational device corresponding to the largest assignation score, or by sampling the computational device in accordance with the assignation scores.

If the expert neural networks in the expert sub-layer are distributed across multiple computational devices, improper balancing across the computational devices can lead to layer inputs being dropped from computation. That is, improper balancing across the computational devices can lead to exceeding the available memory on one or more of the computational devices. Exceeding the available memory on a computational device can cause the computational device “drop” one or more the layer inputs. That is, exceeding the available memory on a computational device can cause the computational device to assign a default value to the corresponding expert output instead of computing the expert output, e.g., the original value of the layer input, which can result in the system losing computational efficiency. More evenly balancing the layer input to expert neural network assignments using the Sinkhorn algorithm can enable the computational devices hosting the expert neural networks to drop fewer layer inputs, thereby increasing computational efficiency by reducing wasted computational resources (e.g., memory and FLOPS).

More generally, the Sinkhorn algorithm can be used even when the gating sub-layer is trained using methods other than reinforcement learning techniques, e.g., using conventional techniques.

The selection engine 210 can select an expert neural network for each layer input based on the assignation scores 208 for the layer input. The selection engine 210 can assign one or more layer inputs to each expert neural network. For example, the selection engine 210 can select the expert neural network for each layer input corresponding to the largest assignation score for the layer input. In another example, the selection engine can determine the expert neural network for each layer input by sampling an expert neural network in accordance with the assignation scores for the layer input.

In cases where the expert neural networks are distributed across multiple computational devices, the selection engine 210 can select an expert neural network stored on the computational device that was selected for the layer input. The selection engine 210 can select the expert neural network based on the gating scores for the expert neural networks on the computational device, e.g., by applying a softmax function to the gating scores and selecting the expert neural network in accordance with the output of the softmax function.

The expert sub-layer 212 is configured to process each layer input in the layer input sequence 202 to generate a respective expert output for the layer input. The expert sub-layer 212 includes multiple expert neural networks (e.g., expert network 216, expert network 218, expert network 220, and expert network 222) to process the layer inputs. The expert sub-layer 212 can process each layer input using the respective expert neural network selected for the layer input by the selection engine 210. For example, the expert network 218 can process layer input 214A to generate expert output 224A. The expert network 222 can process the layer input 214B to generate expert output 224B.

Each expert neural network can have any appropriate neural network architecture that enables it to perform its described function, i.e., processing a layer input to generate a respective expert output. In particular, each expert neural network can include any appropriate types of neural network layers (e.g., fully-connected layers, attention-layers, convolutional layers, etc.) in any appropriate numbers (e.g., 1 layer, 5 layers, or 25 layers), and connected in any appropriate configuration. In a particular example, each expert neural network can be a fully-connected neural network that is configured to process a layer input and to generate a respective expert output for the layer input.

The combination function 226 is configured to process the expert outputs (e.g., expert output 224A and expert output 224B) and to generate the layer output 228. The combination function 226 can combine the expert outputs generated by the expert sub-layer 212 to generate the layer output 228. For example, the combination function 226 can concatenate the expert outputs to generate the layer output 228. In one example, the combination function can generate as the layer output 228 a sequence that includes at each position in the layer input sequence 202 the expert output generated for the layer input at that position.

FIG. 3 is a flow diagram of an example process for training a neural network that has one or more conditional computation layers. For convenience, the process 300 will be described as being performed by a system of one or more computers located in one or more locations. For example, a training system, e.g., the training system 100 of FIG. 1, appropriately programmed in accordance with this specification, can perform the process 300.

The system can perform the steps (302)-(320) at each of multiple training iterations. For convenience, a single training iteration is described below.

The system samples a batch of training examples (302). Each training example can include a target output sequence and a corresponding network input that the neural network should process to generate the target output sequence. Each target output sequence can include a ground truth output token from a vocabulary of output tokens at each of one or more output positions in the target output sequence. For example, the network input can include an input prompt from a user, and the target output sequence can represent a text sequence that is a response to the input sequence. Each output token in the target output sequence can represent a character, a sub-word, a word, or a special token (e.g., a start sequence token, separate token, or a punctuation token) in the text sequence.

For each conditional computation layer, the system receives layer input sequences (304). Each layer input sequence can be generated from a respective network input (e.g., by preceding neural network layers), and can include a respective layer input for each output position in the corresponding target output sequence. For example, each layer input can be represented by a collection of ordered numerical values, such as a vector or matrix of numerical values.

For each conditional computation layer, the system generates a respective set of gating scores for each layer input (306) in each layer input sequence. The conditional computation layer includes a respective gating sub-layer that has multiple gating parameters and a respective expert sub-layer that has multiple expert neural networks. The gating sub-layer can process each layer input in accordance with the gating parameters to generate the respective set of gating scores for the layer input. The respective set of gating scores for the layer input can include a respective gating score corresponding to each expert neural network in the expert sub-layer.

For example, the gating parameters of the gating sub-layer can include a learned vector for each expert neural network in the gating sub-layer, and can generate a respective initial score for each expert neural network by computing a dot product between the learned vector for the expert neural network and the layer input. The gating sub-layer can compute the respective gating scores for the layer input by applying a softmax function to the initial scores.

For each conditional computation layer, the system selects an expert neural network for each layer input (308) in each layer input sequence. In cases where the conditional computation layer includes a gating function, the system can further process the respective gating scores using the gating function to select the expert neural networks. For each layer input sequence, the system can process the respective set of gating scores for each layer input in the layer input sequence using a gating function to generate a respective set of assignation scores for each layer input. The respective set of assignation scores for each layer input can include a respective assignation score for each expert neural network in the expert sub-layer. Each assignation score can represent an updated affinity of the layer input for the respective expert neural network that encourages load balancing across the expert neural networks. The system can select an expert neural network for each layer input in the layer input sequence based on the assignation scores for the layer input, e.g., by selecting the expert neural network corresponding to the largest assignation score, or by sampling an expert neural network in accordance with the assignation scores.

For example, the gating function can apply a Sinkhorn algorithm to the gating scores to generate the assignation scores. The Sinkhorn algorithm maps each layer input to an expert neural network in accordance with the respective gating scores for the layer input while also load balancing the layer inputs across the expert neural networks (i.e., assigning an approximately equal number of layer inputs to each expert neural network). That is, the Sinkhorn algorithm attempts to maximize the affinity of each layer input (e.g., assign the layer input to an expert neural network corresponding to a large gating score) while helping to ensure that each layer input is assigned to an expert neural network and that each expert neural network is assigned the same number of layer inputs, as described above with reference to FIG. 2.

The Sinkhorn algorithm processes the sets of gating scores to generate more evenly balanced layer input to expert neural network assignments. That is, the Sinkhorn algorithm generates the assignation scores such that each expert neural network is more likely to receive an equal number of layer inputs. More evenly distributing the layer inputs across the expert neural networks can enable the system to train the neural network using fewer training iterations, thereby saving computational resources (e.g., memory and FLOPS).

In cases where the expert neural networks are distributed across multiple computational devices, the Sinkhorn algorithm can process the sets of gating scores to generate a set of assignation scores for each layer input, where each assignation score corresponds to a respective computational device. The system can select a computational device for the layer input in accordance with the assignation scores, e.g., by selecting the computational device corresponding to the largest assignation score, or by sampling the computational device in accordance with the assignation scores. The system can select the expert neural network for the layer input in accordance with the gating scores for the expert neural networks on the selected computational device. For example, the system can apply a softmax function across the gating scores to generate updated gating scores, and select the expert neural network in accordance with the updated gating scores, e.g., by selecting the expert neural network corresponding to the largest updated gating score, or by sampling an expert neural network in accordance with updated gating scores.

More evenly distributing the layer inputs across computational devices can enable the system to drop fewer layer inputs and to reduce bottlenecking, thereby reducing computational resource waste (e.g., memory and FLOPS) and training the neural network over fewer training iterations.

In cases where the conditional computation layer does not include a gating function, the system can select the expert neural network for each layer input directly using the gating scores for the layer input, e.g., by selecting the expert neural network corresponding to the largest gating score, or by sampling an expert neural network in accordance with the gating scores.

For each conditional computation layer, the system generates an expert output for each layer input (310). The system can generate the expert output for each layer input using the selected neural network for the layer input. For example, each expert neural network can be a fully-connected network.

For each conditional computation layer, the system generates a respective layer output from the expert outputs (312) for each layer input sequence. The system can generate each layer output by combining the respective expert outputs using a combination function. For example, the combination function can generate each layer output as a sequence that includes at each position in the corresponding layer input sequence the expert output generated for the layer input at that position.

The system generates network outputs (314). The system can generate each network output by processing the corresponding layer output from the final conditional computation layer. Each network output can include a respective score distribution over the output token vocabulary for each output position in the corresponding target output sequence. For example, the neural network can include subsequent neural network layers after the final conditional computation layer to generate the network output. In one example, the subsequent neural network layers can include an attention neural network layer and a fully-connected neural network layer with a softmax function to generate the respective score distributions.

The system generates respective rewards for each gating sub-layer (316). The system can generate a respective reward for the gating sub-layer for each output position in the corresponding target output sequence. The system can generate the respective reward from a respective score assigned to the ground truth output token at the output position by the score distribution of the network output generated by the neural network for the output position.

For example, the score distribution for each output position can represent for each output token in the vocabulary of output tokens a predicted likelihood (e.g., represented by a numerical value) that the output token is the same output token as the ground truth output token at the output position in the target output sequence. The system can determine an “immediate reward” for the gating sub-layer for the output position as a function of the predicted likelihood assigned to the ground truth token by the score distribution. In one example, the immediate reward can be equal to the predicted likelihood. In another example, the immediate reward can be equal to the log of the likelihood.

In another example, the expected reward for the gating sub-layer can be the immediate reward at the output position, plus a time discounted sum of future rewards for output positions following the output position in the target output sequence. The expected reward can be computed as,

Gₘₖ=Σₜ₌ₖ^{T}γ^{t-k}rₘ^{t}, (3)

where m indexes the target output sequences, t indexes the output positions in the target output sequence m, k represents the current output position in the target output sequence, T represents the number of output positions in the target output sequence m, Gₘₖ represents the expected reward for output position k in target output sequence m, γ represents a discount factor (e.g., a real number between zero and one), and rₘ^{t} represents the predicted likelihood assigned to the ground truth output token by the probability distribution at the output position tin the network output corresponding to target output sequence m.

The system trains each of the gating sub-layers through reinforcement learning using the respective rewards for the gating sub-layer for the output positions (318). The system can train the gating sub-layer directly using a policy gradient algorithm to optimize a reinforcement learning objective function that includes one or more terms that measure an expected reward received by the gating sub-layer. The policy gradient for the gating sub-layer can be backpropagated through the remainder of the neural network to update the neural network parameters of the remainder of the neural network.

For example, the policy gradient algorithm can be the REINFORCE algorithm with no baseline, with an objective function that measures an average expected reward for the gating sub-layer. An example of the gradient of the objective function can be computed, as

$$∇ L = \frac{1}{M} {\sum }_{m = 1}^{M} {\sum }_{k = 1}^{T} {G}_{mk} ∇ ln ( {l}_{mkn} ) , \qquad ( 4 )$$

where m indexes the target output sequences, M is the number of target output sequences, k indexes the output positions in the target output sequence m, T is the number of output positions in the target output sequence m, n indexes the selected expert neural networks in the sub-layer, Gₘₖ represents the expected reward for the gating sub-layer for output position k in target output sequence m, lₘₖₙ represents the likelihood of assigning layer input k for target output sequence m to selected expert neural network n, and V represents the gradient with respect to the gating parameters. For example, the likelihood can be represented by the gating score for the expert neural network.

The objective function can also include an entropy term that measures an entropy of the layer input to expert neural network assignments for each gating sub-layer for each layer input sequence. Maximizing the entropy term can encourage the gating sub-layer to more evenly distribute layer inputs in a layer input sequence across the expert neural networks in the expert sub-layer. For example, a Shannon entropy of the layer input to expert neural network assignments for each gating sub-layer for each layer input sequence can be represented as:

$${S}_{m} = - {\sum }_{n = 1}^{N} \frac{{e}_{n}}{E} ln ( \frac{{e}_{n}}{E} ) , \qquad ( 5 )$$

where m indexes the target output sequences, n indexes the expert neural networks in the expert sub-layer, eₙ represents the number of layer inputs assigned to the expert neural network n, and E represents the total number of layer inputs in the layer input sequence. The entropy term can then be represented as a sum of the Shannon entropy terms for each target output sequence, as

$$S = - \frac{1}{M} {\sum }_{m = 1}^{M} {S}_{m} , \qquad ( 6 )$$

where m indexes the target output sequences, M represents the total number of target output sequences, and Sₘ represents the Shannon entropy of layer input to expert neural network assignments for the target output sequence m.

The system can train the rest of the neural network, i.e., the components of the neural network that are not a part of the conditional computation layers and the selected experts in each gating sub-layer, using a supervised learning objective function (320). The system can determine a gradient of the supervised learning objective function (e.g., using backpropagation) for each training example, and apply the gradients to update the neural network parameter values of the rest of neural network using an appropriate gradient descent optimization technique, e.g., RMSprop or Adam.

For example, the supervised learning objective function can include a classification term that measures for each output position in each target output sequence an error between (i) the score distribution generated by the neural network for the output position and (ii) a respective ground truth score distribution based on the ground truth output token at the output position (e.g., a one-hot encoding of the ground truth output token with respect to the output token vocabulary). In one example, the classification term can be a cross-entropy loss term, and the system can train the selected neural networks using an average of the gradients for each output position for each target output sequence.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus for training a neural network having one or more conditional computational layers, wherein each conditional computation layer comprises (i) a gating sub-layer comprising a plurality of gating parameters and (ii) an expert sub-layer comprising a plurality of expert neural networks, to perform a machine learning task, the method comprising:
sampling a batch of training examples, wherein each training example includes a network input and a respective target output sequence that comprises a respective ground truth output token at each of a plurality of output positions, wherein each ground truth output token is selected from a vocabulary of output tokens;
for each training example, processing the network input using the neural network to generate a network output that includes, for each of the plurality of output positions in the target output sequence, a respective score distribution over the vocabulary of output tokens, comprising:
for each of the one or more conditional computation layers:
receiving a layer input sequence for the conditional computation layer that is generated from at least the network input and that comprises a respective layer input for each of the plurality of output positions;
processing each layer input of the layer input sequence using the gating sub-layer and in accordance with current values of the gating parameters to generate a respective set of gating scores for each layer input;
for each layer input:
selecting an expert neural network from the plurality of expert neural networks in the expert sub-layer based at least in part on the respective set of gating scores for the layer input; and
processing the layer input using the respective selected expert neural network to generate a respective expert output for the layer input; and
generating a layer output sequence for the conditional computation layer from the expert outputs for the layer inputs;
for each gating sub-layer and for each output position in each of the target output sequences, generating a reward for the gating sub-layer for the output position from at least a respective score assigned to the ground truth output token at the output position by the score distribution generated by the neural network for the output position; and
training each of the gating sub-layers using the respective rewards for the gating sub-layer for the output positions through reinforcement learning to optimize a reinforcement learning objective function that includes one or more terms that measure an expected reward received by the gating sub-layer.

2. The method of claim 1, further comprising training the selected experts on a supervised learning objective that measures for each output position in each training network output an error between (i) the score distribution generated by the neural network for the output position and (ii) a respective ground truth score distribution based on the ground truth output token at the output position by backpropagating gradients of the supervised learning objective through the neural network.

3. The method of claim 1, wherein for each gating sub-layer the expected reward received by the gating sub-layer is a time discounted sum of the respective rewards for the gating sub-layer for the output positions.

4. The method of claim 1, wherein the reinforcement learning objective function further comprises an entropy term that measures an entropy of the layer input to expert neural network assignments.

5. The method of claim 4, wherein the entropy term measures a Shannon Entropy of the layer input to expert neural network assignments.

6. The method of claim 1, wherein selecting an expert neural network from the expert sub-layer based at least in part on the respective set of gating scores for each layer input comprises:
processing the respective sets of gating scores for the layer inputs using a gating function to generate a respective set of assignation scores for each layer input; and
selecting an expert neural network for each layer input based at least in part on the respective assignation scores for the layer input.

7. The method of claim 6, wherein selecting an expert neural network for each layer input based at least in part on the respective assignation scores for the layer input comprises:
selecting the expert neural network for the layer input corresponding to the largest assignation score for the layer input.

8. The method of claim 6, wherein the gating function is an optimal transport function.

9. The method of claim 8, wherein the gating function applies a Sinkhorn algorithm to the gating scores to generate the assignation scores.

10. The method of claim 1, wherein generating a layer output for each conditional computation layer from the respective expert outputs for the conditional computation layer for the layer inputs comprises concatenating the respective expert outputs for the conditional computation layer for the layer inputs.

11. The method of claim 1, wherein for each of the one or more expert sub-layers, the plurality of expert neural networks in the expert sub-layer are distributed across a plurality of respective computational devices.

12. The method of claim 1, further comprising using the neural network to perform the machine learning task after the neural network has been trained to perform the machine learning task.

13. The method of claim 12, wherein after the neural network has been trained to perform the machine learning task, performing the machine learning task by processing a network input using the neural network to generate a network output that includes for each of a plurality of output positions in the network output a respective score distribution over the vocabulary of output tokens comprises:
for each of the one or more conditional computation layers:
receiving a layer input sequence that is generated from the network input for the conditional computation layer and that comprises one or more layer inputs;
processing each layer input of the layer input sequence using the gating sub-layer and in accordance with current values of the gating parameters to generate a respective set of gating scores;
for each layer input:
selecting an expert neural network from the expert sub-layer based at least in part on the respective set of gating scores for the layer input; and
processing the layer input using the respective selected expert neural network to generate a respective expert output for the layer input; and
generating a layer output for the conditional computation layer from the expert outputs for the one or more layer inputs.

14. The method of claim 13, wherein selecting an expert neural network from the expert sub-layer based at least in part on the respective set of gating scores for each layer input comprises:
selecting the expert neural network for each layer input corresponding to the largest gating score for the layer input.

15. The method of claim 13, further comprising, for each output position in the network output:
selecting an output token for the output position from the vocabulary of output tokens in accordance with the respective score distribution for the output position.

16. The method of claim 15, wherein selecting an output token for the output position from the vocabulary of output tokens in accordance with the respective score distribution for the output position comprises:
selecting the output token from the vocabulary of output tokens that corresponds to the largest score in the respective score distribution for the output position.

17. The method of claim 15, wherein selecting an output token for the output position from the vocabulary of output tokens in accordance with the respective score distribution for the output position comprises:
sampling the output token from the vocabulary of output tokens in accordance with the respective score distribution for the output position.

18. The method of claim 15, wherein the neural network autoregressively generates the output tokens in the network output by processing a combined sequence comprising at least a concatenation of the network input and any output tokens at output positions in the network output preceding the output token.

19. A method performed by one or more data processing apparatus, the method comprising:
processing a network input using a neural network to generate a network output that includes for each of a plurality of output positions in the network output a respective score distribution over the vocabulary of output tokens, wherein the neural network includes one or more conditional computational layers, wherein each conditional computation layer comprises (i) a gating sub-layer comprising a plurality of gating parameters and (ii) an expert sub-layer comprising a plurality of expert neural networks, and wherein the neural network has been trained by performing operations comprising:
sampling a batch of training examples, wherein each training example includes a network input and a respective target output sequence that comprises a respective ground truth output token at each of a plurality of output positions, wherein each ground truth output token is selected from a vocabulary of output tokens;
for each training example, processing the network input using the neural network to generate a network output that includes, for each of the plurality of output positions in the target output sequence, a respective score distribution over the vocabulary of output tokens, comprising:
for each of the one or more conditional computation layers:
receiving a layer input sequence for the conditional computation layer that is generated from at least the network input and that comprises a respective layer input for each of the plurality of output positions;
processing each layer input of the layer input sequence using the gating sub-layer and in accordance with current values of the gating parameters to generate a respective set of gating scores for each layer input;
for each layer input:
selecting an expert neural network from the plurality of expert neural networks in the expert sub-layer based at least in part on the respective set of gating scores for the layer input; and
processing the layer input using the respective selected expert neural network to generate a respective expert output for the layer input; and
generating a layer output sequence for the conditional computation layer from the expert outputs for the layer inputs;
for each gating sub-layer and for each output position in each of the target output sequences, generating a reward for the gating sub-layer for the output position from at least a respective score assigned to the ground truth output token at the output position by the score distribution generated by the neural network for the output position; and
training each of the gating sub-layers using the respective rewards for the gating sub-layer for the output positions through reinforcement learning to optimize a reinforcement learning objective function that includes one or more terms that measure an expected reward received by the gating sub-layer.

20. A system comprising:
one or more computers; and
one or more storage devices storing instructions that, when executed by the one or more computers, cause the one or more computers to implement:
a neural network that is configured to process a network input using a neural network to generate a network output that includes for each of a plurality of output positions in the network output a respective score distribution over the vocabulary of output tokens, wherein the neural network includes one or more conditional computational layers, wherein each conditional computation layer comprises (i) a gating sub-layer comprising a plurality of gating parameters and (ii) an expert sub-layer comprising a plurality of expert neural networks, and wherein the neural network has been trained by performing operations comprising:
sampling a batch of training examples, wherein each training example includes a network input and a respective target output sequence that comprises a respective ground truth output token at each of a plurality of output positions, wherein each ground truth output token is selected from a vocabulary of output tokens;
for each training example, processing the network input using the neural network to generate a network output that includes, for each of the plurality of output positions in the target output sequence, a respective score distribution over the vocabulary of output tokens, comprising:
for each of the one or more conditional computation layers:
receiving a layer input sequence for the conditional computation layer that is generated from at least the network input and that comprises a respective layer input for each of the plurality of output positions;
processing each layer input of the layer input sequence using the gating sub-layer and in accordance with current values of the gating parameters to generate a respective set of gating scores for each layer input;
for each layer input:
selecting an expert neural network from the plurality of expert neural networks in the expert sub-layer based at least in part on the respective set of gating scores for the layer input; and
processing the layer input using the respective selected expert neural network to generate a respective expert output for the layer input; and
generating a layer output sequence for the conditional computation layer from the expert outputs for the layer inputs;
for each gating sub-layer and for each output position in each of the target output sequences, generating a reward for the gating sub-layer for the output position from at least a respective score assigned to the ground truth output token at the output position by the score distribution generated by the neural network for the output position; and
training each of the gating sub-layers using the respective rewards for the gating sub-layer for the output positions through reinforcement learning to optimize a reinforcement learning objective function that includes one or more terms that measure an expected reward received by the gating sub-layer.
